(19) United States
(12) Patent Application Publication
(10) Pub. No.: US 2015/0288659 A1
(43) Pub. Date: Oct. 8, 2015

(54) Systems and Methods for Mutual Integrity Attestation Between A Network Endpoint And A Network Appliance

(71) Applicant: Bitdefender IPR Management Ltd., Nicosia (CY)

(72) Inventors: Sandor LUKACS, Floresti (RO); Adrian V. COLESA, Cluj-Napoca (RO); Dan H. LUTAS, Cluj-Napoca (RO)

(21) Appl. No.: 14/244,505

(22) Filed: Apr. 3, 2014

(51) Int. Cl. H04L 29/06; G06F 21/57; G06F 9/455; G06F 9/44

(52) U.S. Cl. CPC H04L 63/0227; G06F 9/4416; H04L 63/0209; G06F 21/575; G06F 9/45558; G06F 2221/034; G06F 2009/45587

(57) ABSTRACT

Described systems and methods allow malware-protecting a client system (e.g., computer system, smartphone, etc.) connected to a network. In some embodiments, a network appliance transmits a boot image over the network, on demand, to the client system. The boot image may install a hypervisor, which may further load a local OS and applications into a virtual machine. The client system performs a mutual integrity attestation transaction with the network appliance over the network, wherein each side of the transaction verifies the integrity of software objects executing on the other side. When the network appliance determines that the client system is not in a trusted state, the network appliance may block access of the client system to the network. When the client system determines that the network appliance is not in a trusted state, the client system may block communications between the client system and the network appliance.

### BACKGROUND

The invention relates to systems and methods for protecting computer networks and individual computer systems from malware, and in particular systems and methods that use hardware virtualization technology.

An increasing number of goods and services are currently provided online, through electronic communication networks such as the Internet. Examples of online services include, among others, electronic communications, online banking, e-commerce, audio/video conferencing, and online gaming. Providing such services online is often associated with a risk of data theft and/or loss of privacy for a user.

Malicious software, also known as malware, affects a great number of computer systems and other electronic devices worldwide. In its many forms such as computer viruses, worms, exploits, and rootkits, malware presents a serious risk to millions of computer users, making them vulnerable to loss of data and sensitive information, to identity theft, and to loss of productivity, among others. Malware may attempt to steal private or sensitive information, e.g., by intercepting keyboard inputs corresponding to a user's password or credit card number, by intercepting signals from a audio/video device connected to a user's computer system, or by intercepting communication between the malware-infected computer system and a remote computer system. Malware may also disable software such as firewalls and other network filters configured to prevent the respective computer system from carrying out unauthorized communication with remote parties.

In a more sophisticated scenario, an attacker may send a targeted malware agent to a computer system connected to a corporate network. The agent may be camouflaged within an electronic message (e.g., email), and may install a back door module on the receiving computer system. The back door module may allow the attacker to take control of the respective computer system, for instance to mine the corporate network for sensitive information, such as intellectual property.

There is considerable interest in developing anti-malware solutions which are robust, scalable, easily and safely deployable, and adapted to any network configuration.

### SUMMARY

According to one aspect, a network appliance comprises at least one processor configured to execute a client boot agent and an appliance network filter connected to the client boot agent. The client boot agent is configured to transmit a boot image over a network to a client system in response to receiving a boot request from the client system, wherein executing the boot image on a processor of the client system causes a booting of the client system. The appliance network filter is configured to determine whether the client system is in a trusted state of the client system according to a client integrity indicator received from the client system, the client integrity indicator characterizing an integrity of the client system. The appliance network filter is further configured, in response to determining whether the client system is in the trusted state of the client system, to allow electronic communications from the client system when the client system is in the trusted state of the client system, and to block electronic communications from the client system when the client system is not in the trusted state of the client system. The client system is configured to determine whether the network appliance is in a trusted state of the network appliance according to an appliance integrity indicator received from the network appliance, the appliance integrity indicator characterizing an integrity of the network appliance. In response to determining whether the network appliance is in the trusted state of the network appliance, the client system is further configured to employ a client network filter executing on the client system to allow electronic communications between the client system and the network appliance when the network appliance in the trusted state of the network appliance, and to block electronic communications between the client system and the network appliance when the network appliance is not in the trusted state of the network appliance.

According to another aspect, a client system comprises at least one processor configured to transmit a boot request to a network appliance over a network, and in response, to execute a boot image to boot the client system, the boot image received from the network appliance in response to transmitting the boot request. In response to executing the boot image, the at least one processor is further configured to determine whether the network appliance is in a trusted state of the network appliance according to an appliance integrity indicator received from the network appliance, the appliance integrity indicator characterizing an integrity of the network appliance. The at least one processor is further configured, in response to determining whether the network appliance is in the trusted state of the network appliance, to allow electronic communications between the client system and the network appliance when the network appliance in the trusted state of the network appliance, and to block electronic communications between the client system and the network appliance when the network appliance is not in the trusted state of the network appliance. The network appliance is configured to determine whether the client system is in a trusted state of the client system according to a client integrity indicator received from the client system, the client integrity indicator characterizing an integrity of the client system; and in response to determining whether the client system is in the trusted state of the client system, to allow electronic communications from the client system when the client system is in the trusted state of the client system, and to block electronic communications from the client system when the client system is not in the trusted state of the client system.

According to another aspect, a non-transitory computer-readable medium stores instructions which, when executed on a processor of a network appliance, cause the network appliance to form a client boot agent and an appliance network filter connected to the boot agent. The client boot agent is configured to transmit a boot image over a network to a client system in response to receiving a boot request from the client system, wherein executing the boot image on a processor of the client system causes a booting of the client system. The appliance network filter is configured to determine whether the client system is in a trusted state of the client system according to a client integrity indicator received from the client system, the client integrity indicator characterizing an integrity of the client system. The appliance network filter is further configured, in response to determining whether the client system is in the trusted state of the client system, to allow electronic communications from the client system when the client system is in the trusted state of the client system, and to block electronic communications from the client system when the client system is not in the trusted state of the client system. The client system is configured to determine whether the network appliance is in a trusted state of the network appliance according to an appliance integrity indicator received from the network appliance, the appliance integrity indicator characterizing an integrity of the network appliance. In response to determining whether the network appliance is in the trusted state of the network appliance, the client system is further configured to employ a client network filter executing on the client system to allow electronic communications between the client system and the network appliance when the network appliance in the trusted state of the network appliance, and to block electronic communications between the client system and the network appliance when the network appliance is not in the trusted state of the network appliance.

### BRIEF DESCRIPTION OF THE DRAWINGS

The foregoing aspects and advantages of the present invention will become better understood upon reading the following detailed description and upon reference to the drawings where:

FIG. 1 shows an exemplary set of client systems and a network appliance protected from malware according to some embodiments of the present invention, the client systems configured to perform mutual integrity attestation with the network appliance.

FIG. 2 shows an exemplary hardware configuration of a client system according to some embodiments of the present invention.

FIG. 3 shows an exemplary hardware configuration of the network appliance according to some embodiments of the present invention.

FIG. 4-A shows an exemplary set of software objects executing on a client system according to some embodiments of the present invention.

FIG. 4-B shows an alternative configuration of software objects executing on the client system according to some embodiments of the present invention.

FIG. 4-C shows yet another configuration of software objects executing on the client system according to some embodiments of the present invention.

FIG. 5 illustrates exemplary software objects executing on the network appliance according to some embodiments of the present invention.

FIG. 6 shows an exemplary boot transaction between the client system and network appliance, according to some embodiments of the present invention.

FIG. 7 shows an exemplary mutual integrity attestation transaction between the client system and network appliance according to some embodiments of the present invention.

FIG. 8 illustrates an exemplary sequence of steps performed by the network appliance to set up malware protection and mutual integrity attestation according to some embodiments of the present invention.

FIG. 9 shows an exemplary sequence of steps performed by the client system to set up malware protection and mutual integrity attestation according to some embodiments of the present invention.

FIG. 10 shows an exemplary sequence of steps performed by the network appliance to carry out mutual integrity attestation and malware protection according to some embodiments of the present invention.

FIG. 11 an exemplary sequence of steps performed by the client system to carry out mutual integrity attestation and malware protection according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Unless otherwise specified, a hash is an output of a hash function. Unless otherwise specified, a hash function is a mathematical transformation mapping a variable-length sequence of symbols (e.g. characters, bits) to fixed-length data such as a number or bit string. Unless otherwise specified, a page represents the smallest unit of virtualized memory individually mapped to a physical memory of a computer system. Computer readable media encompass non-transitory media such as magnetic, optic, and semiconductor storage media (e.g. hard drives, optical disks, flash memory, DRAM), as well as communications links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

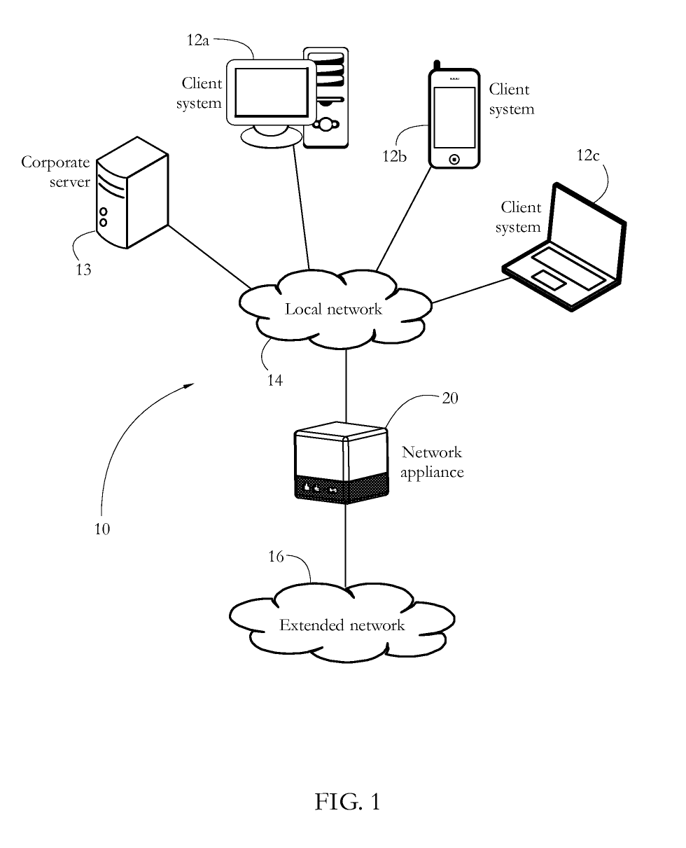

FIG. 1 shows an exemplary anti-malware system 10 according to some embodiments of the present invention. System 10 comprises a set of client systems 12a-c and a network appliance 20, interconnected via a local communication network 14. In some embodiments, local network 14 includes at least an Open System Interconnection (OSI) layer 2 device, such as a network switch. In one example, client systems 12a-c may represent corporate end-user devices, such as personal computers and laptops, while network 14 may represent a corporate Intranet and/or a local area network (LAN). Client systems 12a-c may further connect via network 14 to a corporate server 13, for instance to access and/or exchange sensitive data. In another example, client systems 12a-c may represent electronic devices such as laptops, smartphones, game consoles, and other home appliances, interconnected by a home network. Client systems 12a-c may be configured to request and receive a below-operating system security solution from network appliance 20, and further configured to perform a mutual integrity attestation with network appliance 20, as shown in detail below.

In some embodiments, network appliance 20 is a stand-alone electronic device/computer system including a processor and a memory unit, and configurable to control access of devices 12a-c to an extended communication network 16, which may include a wide area network such as the Internet. In some embodiments, extended network 16 includes at least one device performing activities included in OSI layer 4 (e.g., data transport). In one exemplary configuration, network appliance 20 provides a unique access point to extended network 16 from within local network 14, i.e., all data traffic between client systems 12a-c and extended network 16 is routed through network appliance 20. In some embodiments, controlling access to network 16 comprises selectively allowing, blocking, or in any other way restricting data traffic between a client system 12a-c and an electronic device connected to network 16, but not connected to local network 14. Exemplary network appliances 20 include a router, a wireless access point, a firewall appliance, a network gateway, and other network appliances configurable to control access of client systems 12a-c to extended network 16. Beside controlling data traffic, some embodiments of network appliance 20 may be configured to deliver a below-operating system security solution to client systems 12a-c and/or to perform mutual integrity attestation with client systems 12a-c, as shown below.

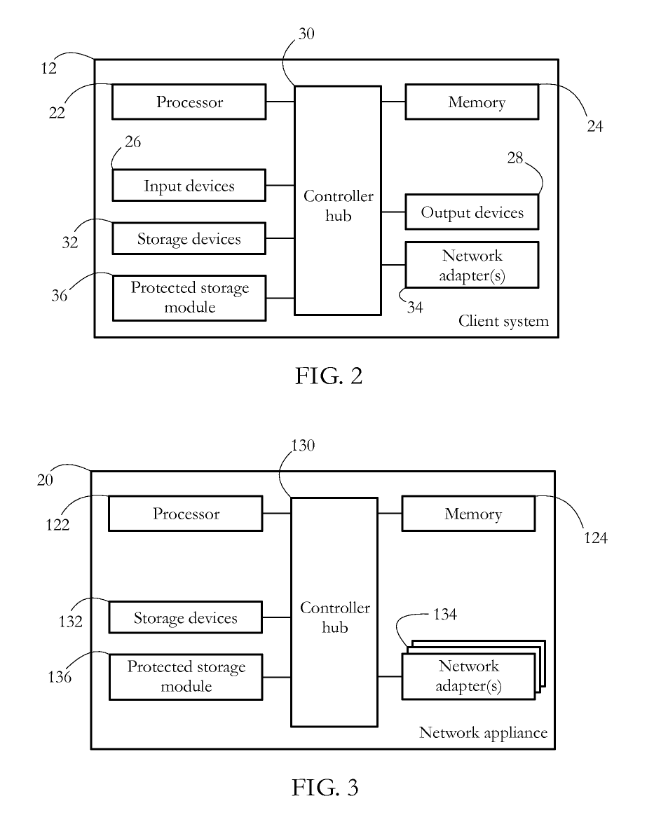

FIG. 2 shows an exemplary hardware configuration of a client system 12, such as client systems 12a-c in FIG. 1. A computer system was chosen for illustrative purposes; other devices such as smartphones may have a different configuration. In some embodiments, client system 12 comprises a processor 22, a memory unit 24, a set of input devices 26, a set of output devices 28, a set of storage devices 32, and a set of network adapter(s) 34, all interconnected by a controller hub 30.

In some embodiments, processor 22 comprises a physical device (e.g. multi-core integrated circuit) configured to execute computational and/or logical operations with a set of signals and/or data. In some embodiments, such logical operations are delivered to processor 22 in the form of a sequence of processor instructions (e.g. machine code or other type of software). Memory unit 24 may comprise volatile computer-readable media (e.g. RAM) storing data/signals accessed or generated by processor 22 in the course of carrying out instructions. Input devices 26 may include computer keyboards, mice, and microphones, among others, including the respective hardware interfaces and/or adapters enabling a user to introduce data and/or instructions into client system 12. Output devices 28 may include display devices such as monitors and speakers among others, as well as hardware interfaces/adapters such as graphic cards, enabling client system 12 to communicate data to a user. In some embodiments, input devices 26 and output devices 28 may share a common piece of hardware, as in the case of touch-screen devices. Storage devices 32 include computer-readable media enabling the non-volatile storage, reading, and writing of software instructions and/or data. Exemplary storage devices 32 include magnetic and optical disks and flash memory devices, as well as removable media such as CD and/or DVD disks and drives. Network adapter(s) 34 enable client system 12 to connect to network 14 and/or to other devices/computer systems. Controller hub 30 represents the plurality of system, peripheral, and/or chipset buses, and/or all other circuitry enabling the communication between processor 22 and devices 24, 26, 28, 32, and 34. For instance, controller hub 30 may include a memory controller, an input/output (I/O) controller, and an interrupt controller, among others.

In some embodiments, client system 12 further includes a protected storage module 36 connected to hub 30. Module 36 comprises a hardware device, e.g., an integrated circuit, configured to securely store sensitive information, such as integrity indicators (e.g., hashes) of software objects executing on client system 12 and/or network appliance 20. Module 36 may comprise a persistent memory configured so that software executing on the respective client system may not overwrite a content of the respective module. Such persistent memory may be used to store a cryptographic key uniquely associated with the respective module and/or with client system 12 (such keys are known as endorsement keys in some embodiments). Module 36 may also comprise a writable memory, configured so that selected software objects executing on the respective client system are allowed to overwrite data stored in the writable memory. For instance, module 36 may be configured so that only software components of a hypervisor and/or other software executing at root privilege level may have write permission to a memory of module 36 (see more details below). In some embodiments, protected storage module 36 also comprises a cryptographic processor configured to generate cryptographic keys, to compute hashes, and/or to perform encryption/decryption of data. Exemplary protected storage modules 36 include trusted platform module (TPM) chips produced by various hardware manufacturers. In an alternative embodiment, protected storage module 36 may be software-emulated, for instance using ARM TrustZone® technology.

FIG. 3 shows an exemplary hardware configuration of network appliance 20, according to some embodiments of the present invention. Appliance 20 comprises a processor 122, a memory 124, storage devices 132, network adapter(s) 134, and protected storage module 136. Processor 122 may execute computational and/or logical operations with a set of signals and/or data. Memory unit 124 may comprise volatile computer-readable media (e.g. RAM) storing data/signals accessed or generated by processor 122 in the course of carrying out operations. Storage devices 132 include computer-readable media enabling the non-volatile storage, reading, and writing of software instructions and/or data. For instance, storage device 132 may be configured to store a database of hypervisor images and/or a database of software integrity indicators, as shown below. Network adapters 134 may connect network appliance 20 to local network 14 and extended network 16, and enable data transmission between client systems 12a-c and other computer systems/devices connected to network 16.

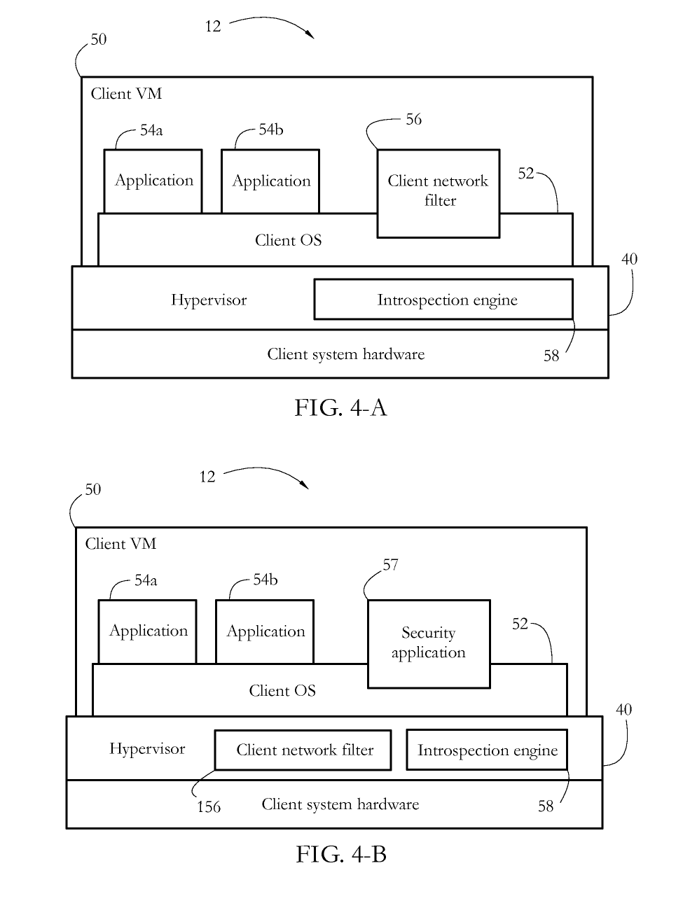

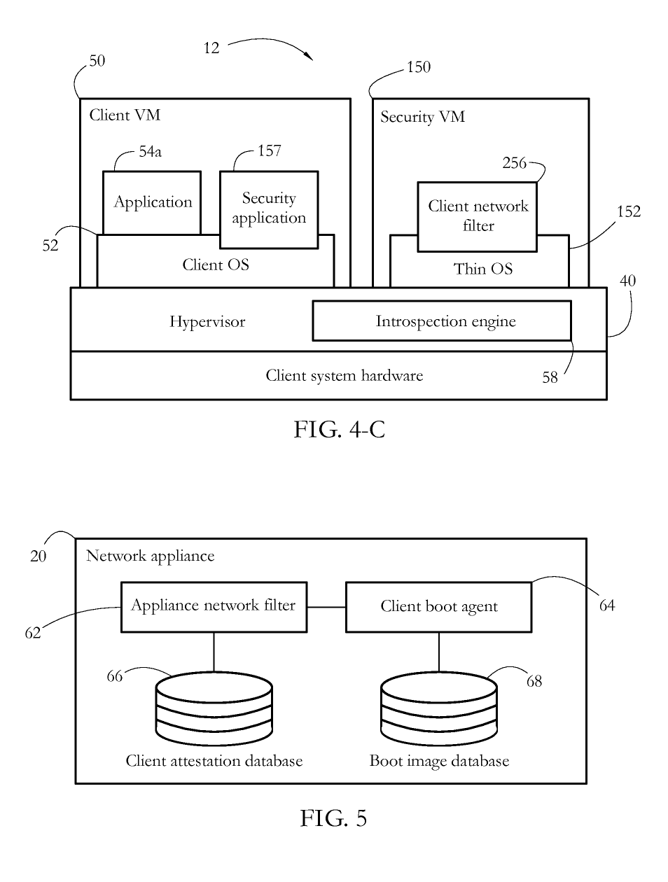

FIG. 4-A shows an exemplary software configuration of client system 12. In some embodiments, client system 12 is configured to execute a hypervisor (HV) 40, the hypervisor further configured to expose a client virtual machine (VM) 50. Virtual machine 50 comprises a software abstraction, for instance an emulation, of an actual physical computing device, the abstraction enabling VM 50 to execute a client operating system (OS) 52 and/or a set of other software applications 54a-b, as if VM 50 possessed a set of physical hardware devices. In some embodiments, hypervisor 40, also known in the art as a virtual machine monitor (VMM), comprises software which creates the virtual environment of client VM 50, an operation known in the art of virtualization as exposing VM 50. Exposing VM 50 may include creating a plurality of virtual devices, each virtual device emulating the operation and functionality of a physical hardware device of client system 12, such as a processor and a memory controller, among others. Hypervisor 40 may further assign a set of virtual devices to each exposed VM executing on client system 12. Examples of popular hypervisors include the VMware ESXi™ from VMware Inc. and the open-source Xen hypervisor, among others.

Client OS 52 provides an interface between software applications, such as applications 54a-b, and the virtualized hardware devices of client VM 50. Client OS 52 may comprise any widely available operating system such as Windows®, MacOS®, Linux®, iOS®, or Android™, among others. Applications 54a-b generically represent any application such as word processing, image processing, media player, database, calendar, personal contact management, browser, gaming, voice communication, and data communication applications, among others.

Some hardware platforms feature a hierarchy of protection domains, also known in the art as layers or protection rings. Each such layer or ring is associated to a distinct processor privilege level, so that software executing at a certain privilege level cannot directly access resources requiring higher processor privileges. When a software object attempts to perform an action which is not allowed within the respective privilege level, the attempt may trigger a processor event, such as an exception or a fault. In some embodiments, hypervisor 40 takes control of processor 22 at the most privileged level (e.g., VMXroot on Intel® platforms supporting virtualization, also known generically as ring −1 or root mode). Most components of client OS 52 may execute at a privilege level typically known as ring 0 or kernel-mode, less privileged than hypervisor 40. From this perspective, hypervisor 40 is said to execute below OS 52. Applications 54a-b typically execute with lesser processor privileges than client OS 52, for instance in ring 3 or user-mode.

In some embodiments, an introspection engine 58 executes at a processor privilege level similar to hypervisor 40, i.e. below OS 52, and is configured to perform introspection of VM 50. Such introspection may include analyzing a behavior of a software object executing within VM 50, determining and/or accessing memory addresses of such software objects, and analyzing a content of memory located at such addresses, among others. Engine 58 may be further configured to protect certain software, such as components of OS 52 and network filter 56, from malware. Protection may be achieved using any method known in the art, for instance by preventing changes to a content of a memory page hosting a part of the protected object. Introspection engine 58 may be integrated into hypervisor 40 or may be installed as a separate component. The operation of introspection engine 58 will be further detailed below.

In some embodiments, client VM 50 further executes a client network filter 56, configured to control electronic communication between client system 12 and other electronic devices/computer systems connected to networks 14 and/or 16. Controlling such electronic communication may include selectively allowing or blocking transmission of data between client system 12 and network appliance 20. Some components of client network filter 56 may execute at a processor privilege level similar to that of client OS 52 (e.g., kernel mode), while other components may execute at lesser processor privilege (e.g., user-mode).

FIG. 4-B shows an alternative software configuration of client system 12, wherein a client network filter 156 executes below client OS 52, at the processor privilege level of hypervisor 40. Filter 156 may have the same function as filter 56 of FIG. 4-A, i.e., to control electronic communication between client system 12 and appliance 20 (or another device connected to networks 14, 16). In some embodiments, filter 156 operates in conjunction with a software agent executing within client VM 50, such as a security application 57 depicted in FIG. 4-B.

In typical digital communication protocols, data circulating between two endpoints is segmented into data units, commonly known as data packets. Each data unit may comprise a header and a payload, the header including information such as network routing addresses, and the payload comprising a fragment of the data itself The bit size and/or formatting of data units may be protocol-specific. To control electronic communication from a level below OS 52, some embodiments of client filter 156 may intercept an attempt by software executing within client VM 50 to send a data packet to another system on the network. In one example, such interception is achieved via VM exit processor events, which transfer control of processor 22 from client VM 50 to HV 40. Security application 57 may install a software driver configured to interface with a virtual network adapter of client VM 50, the virtual network adapter emulated by hypervisor 40. The driver may include processor instructions such as VMCall and/or VMFunc on Intel platforms, which trigger VM exit events, thus signaling client network filter 156 that data is being sent from within 150. In some embodiments, the actual data packet being sent is transferred from client VM 50 to HV 40 through memory pages shared by VM 50 and HV 40. To filter incoming communications, client network filter 165 may be configured to interface directly with physical network adapter(s) 34 of client system 12, to receive a data packet destined for a software component (e.g., browser) executing within client VM 50. To allow transmission of the respective data packet, client network filter 156 may use an interrupt injection mechanism to notify the software driver within client VM 50 that data is being received from the network. Several such interrupt injection techniques are known in the art of virtualization; they represent a subclass of vectored event injection mechanisms, which inject processor events into a virtual machine when transferring control of the processor from a hypervisor to a virtual machine controlled by the hypervisor (in the present example, from HV 40 onto client VM 50).

Filter 156 may be incorporated into hypervisor 40, or may be operate as a separate component. In some embodiments, client network filter 156 is delivered by network appliance 20 to client system 12 as part of a boot image.

FIG. 4-C shows yet another alternative embodiment of client system 12, wherein a client network filter 256 executes within a security VM 150 distinct from client VM 50. Filter 256 may be configured to control communication between client VM 50 and the network. In one such embodiment, hypervisor 40 virtualizes only a subset of the hardware devices of client system 12, while giving VM 50 and 150 exclusive access to selected hardware devices. For instance, each of VM 50 and 150 may be configured to have a virtual processor and a virtual memory unit. Memory virtualization enables security VM 150 to operate with its own memory space, isolated from the memory space of client VM 50, which increases security. Hypervisor 40 may give client VM 50 exclusive access to input devices 26 and output devices 28, while giving security VM 150 exclusive access to network adapter(s) 34. Such configurations may be enabled, for instance, using VT-d® technology from Intel®. HV 40 may be further configured to re-route all network traffic to/from client VM 50 through security VM 150, thus intercepting such traffic and selectively allowing or blocking it, as shown further below. Re-routing network traffic through security VM 150 may be achieved, for instance, using a combination of VM exit event triggering and interrupt injection, as described above, in relation to FIG. 4-B. In some embodiments, such re-routing may be facilitated by using a software agent executing within client VM 50, such as a security application 157 illustrated in FIG. 4-C. In one such example, security application 157 may be configured to detect an attempt by software executing within client VM 50 to send a data packet to network adapter(s) 34, and in response, to notify HV 40, for instance, by triggering a VM exit event.

FIG. 5 shows exemplary software components executing on network appliance 20 according to some embodiments of the present invention. Appliance 20 may include an appliance network filter 62 and a client boot agent 64 connected to appliance network filter 62. In some embodiments wherein appliance 20 is configurable to support hardware virtualization, appliance 20 may be configured to run an appliance hypervisor and/or an appliance OS (e.g. a customized version of Linux®) below filter 62 and boot agent 64.

In some embodiments, client boot agent 64 is configured to conduct a boot transaction with a client system. Filter 62 may be configured to conduct a mutual integrity attestation transaction with client systems 12a-c and to control access of client systems 12a-c to extended network 16. Controlling access of a client system to network 16 may comprise verifying the integrity of software components executing on the respective client system, and, when integrity is not confirmed, refusing a network connection request from the client system, and/or selectively denying the respective client system access to certain addresses on extended network 16. Appliance network filter 62 may be further configured to analyze network packets according to a packet header and/or payload, to determine whether such packets carry malware.

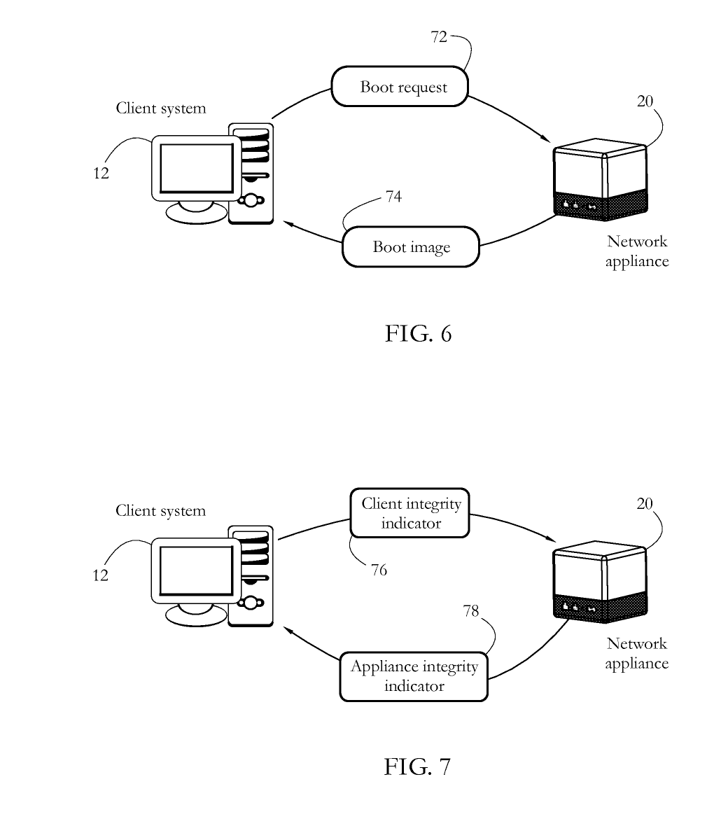

An exemplary boot transaction between client system 12 and network appliance 20 is illustrated in FIG. 6. In some embodiments, the boot transaction includes client system 12 sending a boot request 72 to appliance 20, and in response, appliance 20 transmitting a boot image 74 to the requesting client system. An exemplary boot request 72 includes a request for an address (e.g., file path) of a boot image file. Request 72 may be generated by firmware of client system 12, for instance by a boot loader or PXE client module.

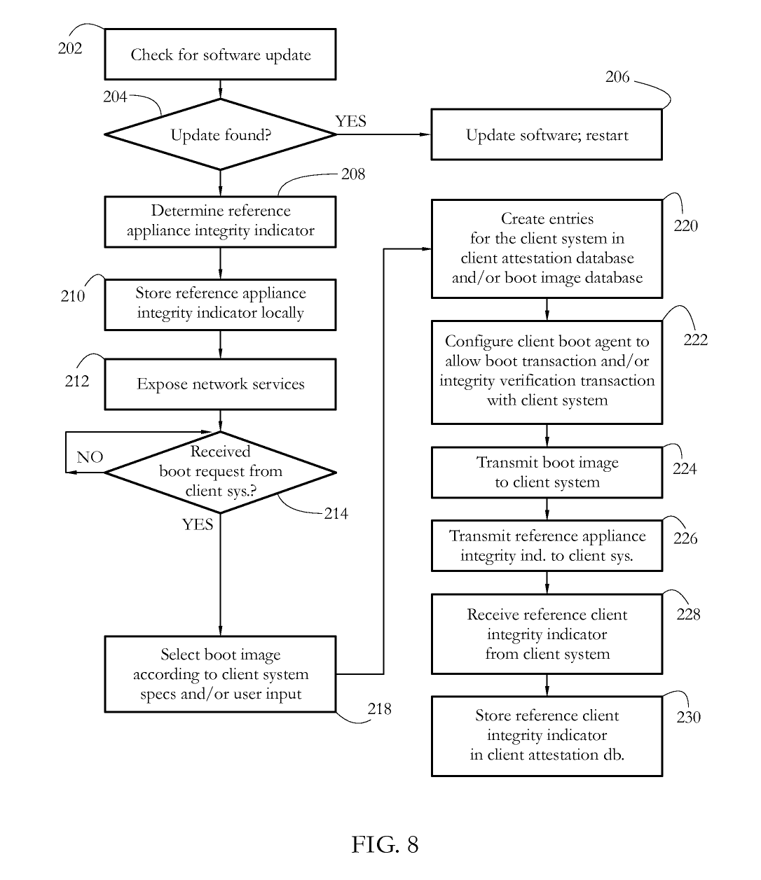

An exemplary mutual integrity attestation transaction between client system 12 and network appliance 20 is illustrated in FIG. 7. In some embodiments, the mutual integrity attestation transaction includes client system 12 sending a client integrity indicator 76 to appliance 20, and appliance 20 sending an appliance integrity indicator 78 to the respective client system. Client integrity indicator 76 may comprise at least one hash of a memory image of a software object currently loaded into the memory of the respective client system. Examples of such software objects include a firmware interface (e.g., BIOS), hypervisor 40, client OS 52, and client network filter 56, among others. Client integrity indicator 76 is indicative of the integrity of the respective software object, i.e., of whether the respective software object is currently in a reference, trusted state. In some embodiments, the trusted state of client system 12 represents a state wherein the current instance of a software object (e.g., hypervisor 40) is identical to the instance of the respective software object received from network appliance as part of boot image 74.

In some embodiments, appliance integrity indicator 78 includes at least a hash of a memory image of a software object currently loaded into the memory of network appliance 20. Such software objects may include, among others, a firmware of appliance 20, a hypervisor of appliance 20, an operating system of appliance 20, and appliance network filter 62. Appliance integrity indicator 78 is indicative of whether software of network appliance 20 is currently in a reference, trusted state. In some embodiments, the trusted state of network appliance 20 represents a state wherein the current instance of a software object (e.g., network filter 62) is identical to a trusted version, for instance, a factory-installed version of the respective software object.

Network appliance 20 (FIG. 5) may further include a client attestation database 66 and a boot image database 68. Databases 66 and 68 may be stored on storage devices 132 of network appliance 20, or may reside on computer-readable media connected to appliance 20. Attestation database 66 includes a set of reference integrity indicators determined for client systems 12a-c. In some embodiments, each such integrity indicator includes a hash of a memory image of a software object installed on the respective client system (e.g., hypervisor 40, client OS 52, etc.). In some embodiments, each reference integrity indicator corresponds to the trusted state of the respective client system. Having a local repository of reference integrity indicators received from various client systems allows network appliance 20 to determine whether a client system is currently in the trusted state, for instance by comparing current client integrity indicator 76 to a reference integrity indicator of the same client system, stored in database 66. A match may indicate that the respective client system 12 is in the trusted state.

Reference integrity indicators may be encrypted and/or cryptographically signed with a key specific to the respective client system, for instance by a cryptographic processor of protected storage module 36 of the respective client system. Each integrity indicator may include an indicator of the client system for which it was calculated, to allow appliance network filter 62 to selectively retrieve the respective integrity measurement from database 66.

Boot image database 68 may store a set of boot images, each of which may be used to boot a particular client system. In some embodiments, a boot image includes a data file (e.g., binary executable) comprising a set of processor instructions, which, when executed by a processor of a client system, launches an instance of hypervisor 40 on the respective client system. In some embodiments, the boot image further contains components of client OS 52, introspection engine 58, and/or client network filter 56. Each boot image stored in database 68 may be tailored to the hardware specifications of a client system (e.g., smartphone vs. personal computer, various models within each category) and/or to a type of client OS (e.g., Windows® vs. Android®, various versions or releases). Each boot image may be configured by a network administrator to have a distinct set of features. In some embodiments, a plurality of prefabricated boot images may be obtained from a security vendor. Boot images may come pre-packaged with network appliance 20 or may be downloaded by network appliance 20 from a dedicated server. Boot images may be further kept up-to-date via periodic and/or on-demand software updates.

FIG. 8 illustrates an exemplary sequence of steps performed by network appliance 20 to set up malware protection and integrity attestation according to some embodiments of the present invention. When installing network appliance 20, a network administrator may place appliance 20 in a network gateway configuration, wherein all connections between client systems 12a-c and extended network 16 must go through appliance 20. After the initial boot of appliance 20, a sequence of steps 202-204-206 may perform a software update, for instance to update a set of boot images.

In a step 208, appliance 20 may determine a reference appliance integrity indicator corresponding to the trusted state of appliance 20. The reference appliance integrity indicator may be later used to determine whether the current state of appliance 20 is the trusted state, i.e., whether software executing on appliance 20 has not been modified, for instance by malware. The reference appliance integrity indicator may include at least one integrity measurement (e.g., a hash) of a memory image of a software component of appliance 20, such as a hash of a memory image of the operating system of appliance 20, and/or a hash of a memory image of appliance network filter 62. A step 210 stores the reference appliance integrity indicator to a sealed storage of appliance 20, e.g., to protected storage module 136. In some embodiments, the reference appliance integrity indicator is further encrypted and/or signed with a signature/key uniquely associated to appliance 20.

In a step 212, appliance 20 may expose network services to client systems 12a-c. Such services may implement any network communication protocol used in the art, according to standards such as Ethernet, wireless LAN, and Bluetooth, among others. In some embodiments, network services enabled by appliance 20 further include implementations of the dynamic host configuration protocol (DHCP), and trivial file transfer protocol (TFTP), among others. Other examples of network services employ encrypted communications protocols such as secure file transfer protocol (SFTP), and SSH File Transfer Protocol, among others.

A sequence of steps 214-230 may be repeated for each client system 12a-c on local network 14. A step 214 waits for a first-time boot request from a client system. Upon receiving the first-time boot request from client system 12, in a step 218, appliance 20 may select boot image 74 from boot image database 68 according to hardware and/or software specifications of the respective client system. For instance, the selection may be done according to a type of device (smartphone vs. personal computer), according to a processor speed and/or amount of available memory, according to a type of OS (Windows® vs. Linux® or iOS®), etc. The selection may be automatic or assisted by a network administrator.

In a step 220, network appliance 20 may create entries for client system 12 in boot image database 68 and/or client attestation database 66, to enable an unambiguous association between the respective client system and the selected boot image, and between the client system and the client system's integrity indicators, respectively. A step 222 may configure client boot agent 64 to allow boot transactions (FIG. 6) and/or mutual integrity attestation transactions (FIG. 7) between appliance 20 and client system 12. In an exemplary embodiment, step 222 includes configuring network appliance 20 to act as a pre-boot execution environment (PXE) server for client system 12.

In a step 224, appliance 20 may transmit boot image 74 to client system 12, for example by establishing a communication channel between appliance 20 and client system 12, and allowing client system 12 to download boot image 74. In a step 226, network appliance 20 may transmit the reference appliance integrity indicator determined in step 208 to client system 12. In a sequence of steps 228-230, appliance 20 may receive reference client integrity indicators from client system 12 and store such indicators in client attestation database 66, associating each indicator with the respective client system. Storing client integrity indicators in database 66 may be conditioned upon administrator approval (for instance, appliance 20 may ask a user to confirm before committing the client integrity indicator to storage).

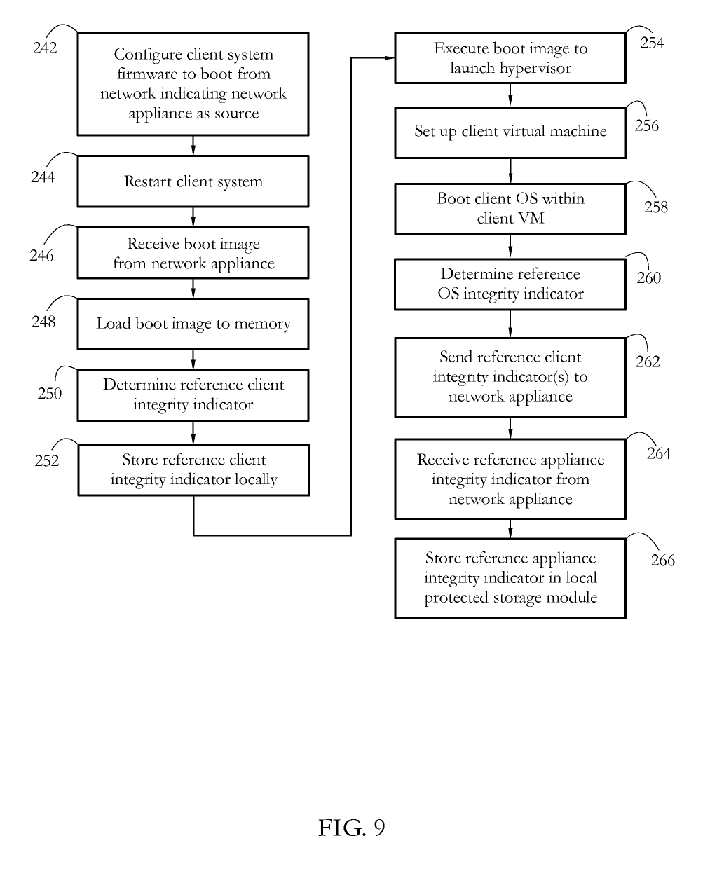

FIG. 9 shows an exemplary sequence of steps performed by client system 12 to set up malware protection and integrity attestation according to some embodiments of the present invention. A step 242 may configure client system 12 (e.g., a firmware or boot loader) to boot from network, indicating network appliance 20 as a source/path. In a step 244, client system 12 is restarted, to force client system 12 to request boot image 74 from appliance 20. In some embodiments, restarting client system 12 further includes determining a firmware integrity indicator characterizing the integrity of a firmware interface (e.g., BIOS) executing on client system 12. The firmware integrity indicator may be included in the reference client integrity indicator transmitted to network appliance 20 as shown below.

After receiving boot image 74, a step 248 loads boot image into memory. In a step 250, client system 12 computes a set of reference integrity indicators (e.g., hashes) corresponding to the trusted state of client system 12. Such reference integrity indicators may comprise a hash of a memory image of hypervisor 40, among others. In some embodiments, such integrity indicators may be determined using trusted execution technology (TXT) from Intel®. A copy of the client reference integrity indicators may be stored locally, for instance, within protected storage module 36.

In a step 254, client system 12 executes boot image 74 to launch hypervisor 40. HV 40 further sets up the virtual environment of client VM 50, which may include creating and configuring virtual devices of VM 50, such as a virtual processor, a virtual memory unit, and a virtual memory controller, among others. In some embodiments, HV 40 only virtualizes a subset of the hardware devices of client system 12. Other devices, such as input devices 26, output devices 28, and network adapter(s) 34 may be accessed directly by software executing within client VM 50, without using an intermediate virtualization layer. Such mixed virtualization configurations are also known in the art as PCI Express device pass-through, and may be enabled, for instance, using VT-d® technology from Intel®. Pass-through configurations may reduce the computational overhead, improving user experience.

In some embodiments configured as illustrated in FIG. 4-C, step 256 comprises setting up both client VM 50 and security VM 150, which may include enabling a set of virtualized physical devices (processor, memory, etc.) and assigning each such virtualized device to either VM 50 or VM 150. In some embodiments, hypervisor 40 may further configure each VM to have exclusive use of some hardware devices. For instance, security VM 150 may be configured to have exclusive use of network adapter(s) 34. Step 256 may further comprise computing a reference integrity indicator for security VM 150.

In a step 258, HV 40 may boot client OS 52 within the virtual environment of client VM 50. Step 258 may include locating a bootable file of OS 52 on local storage device 32 of client system 12, and loading the respective file into memory. A step 260 may further include determining a reference OS integrity indicator (e.g., a hash of a component of OS 52) before launching OS 52 into execution. Such measurements may allow a verification of the integrity of OS 52, to ensure that OS 52 has not been modified, possibly with malicious intent, since a previous boot.

After launching client OS 52, in a step 262, client system 12 transmits the reference client integrity indicators to network appliance 20. Such reference integrity indicators may include, among others, a firmware integrity indicator (step 244), the reference integrity indicator determined for HV 40 (step 250), the reference integrity indicator determined for client OS 52 (step 260), and the reference integrity indicator determined for security VM 150 (step 256).

A sequence of steps 262-264 receives from network appliance 20 a reference appliance integrity indicator determined for appliance 20, and stores the respective indicator locally, for instance within protected storage module 36. Storing reference appliance integrity indicators locally allows client system 12 to later perform an integrity attestation of appliance 20, to determine whether appliance 20 is in a trusted state. Local storage of the reference appliance integrity indicator may be conditioned upon administrator approval (for instance, client system 12 may ask a user to confirm before committing the reference appliance integrity indicator to protected storage module 36).

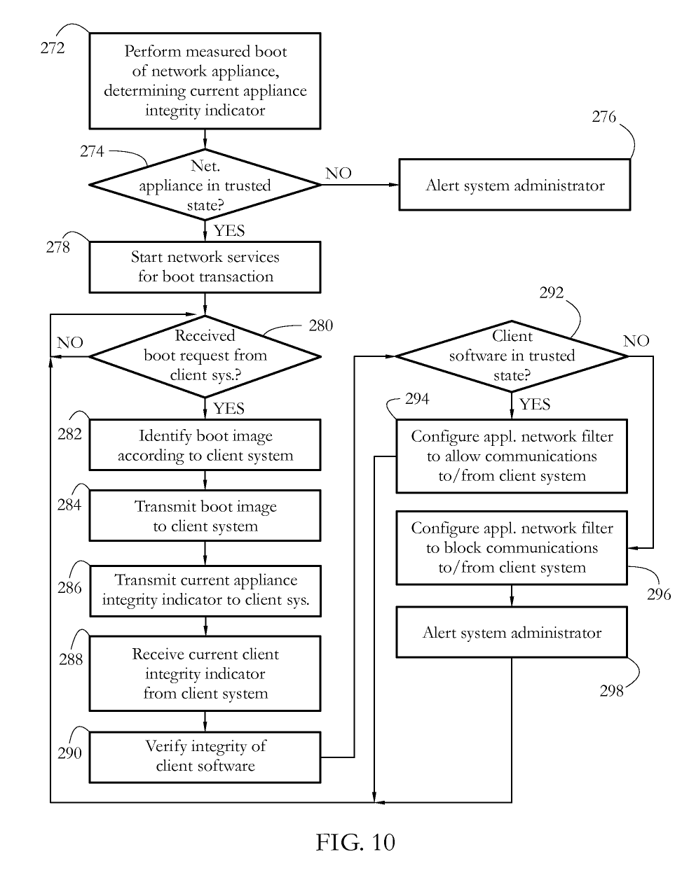

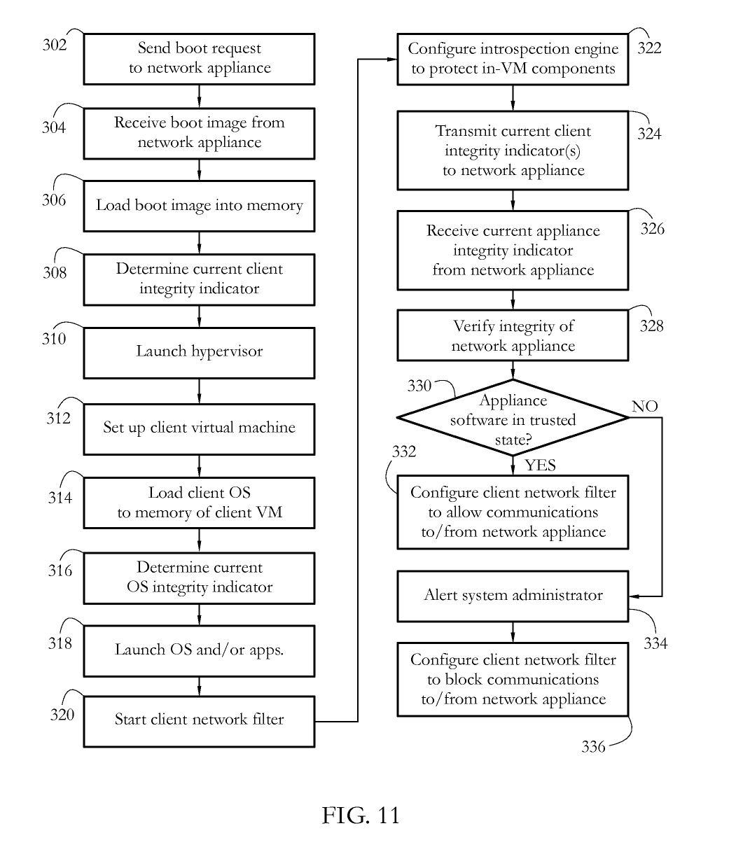

FIG. 10 illustrates an exemplary sequence of steps performed by network appliance 20 to protect client systems 12a-c from malware according to some embodiments of the present invention. A sequence of steps 272-274 may perform a measured boot of network appliance 20. Such measured boot operations may be carried out using, for instance, an Intel TXT® framework, and may include loading appliance software into a memory of appliance 20, calculating appliance integrity indicator 78 (e.g., a hash of a memory image of the respective software), and comparing the current integrity indicator with a reference integrity indicator previously determined for appliance 20 (e.g., steps 208-210 of setup, FIG. 8). When the two integrity indicators do not match, indicating that the current software is not in the trusted state, a step 276 may alert a system administrator.

When the measured launch of appliance 20 was successful, a step 278 exposes network services to client systems 12a-c. In a step 280, appliance 20 then waits for a boot request from a client system. In response to receiving boot request 72 from client system 12, in a sequence 282-284, network appliance 20 looks up boot image 74 corresponding to client system 12 in boot image database 68, and transmits image 74 to client system 12 over network 14.

In steps 286 and 288, appliance 20 performs a mutual integrity attestation transaction with client system 12, i.e., transmits current appliance integrity indicator 78 to client system 12, and receives from system 12 current client integrity indicator 76. In response, in a step 290, network appliance 290 may verify the integrity of software executing on client system 12. Integrity verification may determine whether the respective software (e.g., HV 40, client OS 52, client network filter 56, etc.) have been modified/corrupted since the computation of the reference hash, for instance by malware executing on the client system, or by a user having access to the client system. Step 290 may comprise looking up in client attestation database 66 a reference integrity indicator determined for client system 12, the reference indicator corresponding to a trusted state of client system 12, and comparing client integrity indicator 76 to the respective reference integrity indicator. A match may indicate that client system is in the trusted state.

When integrity verification concludes that client system 12 is in the trusted state, in a step 294, network appliance 20 configures appliance network filter 62 to allow electronic communications between client system 12 and other devices on extended network 16. A mismatch between current client integrity indicator 76 and the reference client integrity indicator may denote an unauthorized and possibly malicious modification of the respective software component, e.g., of HV 40. In such cases, a step 296 may configure appliance network filter 62 to restrict access of client system 12 to extended network 16. Restricting access may include, for instance, blocking access of system 12 to addresses within extended network 16. Such restrictions may prevent client system 12 from performing unauthorized communications with a third party on extended network 16, for instance to transmit sensitive information outside of local network 14. In some embodiments, a step 298 further alerts a system administrator.

FIG. 11 shows an exemplary sequence of steps performed by client system 12 to carry out malware protection and mutual integrity attestation according to some embodiments of the present invention. As shown above in relation to FIG. 9, client system 12 may be configured to boot from network. When such a client system is started, a sequence of steps 302-304 carry out a boot transaction with network appliance 20. In response to receiving boot image 74, some embodiments of client system 12 may perform a measured boot, comprising loading boot image 74 into a memory of client system 12 (step 306), and determining a current client integrity indicator of client system (step 308). The current client integrity indicator may include, for instance, a hash of an image of HV 40 currently residing in memory. In some embodiments, the current client integrity indicator may further include a firmware integrity indicator characterizing the integrity of a firmware interface of client system 12.

In some embodiments, step 308 may further include comparing the current client integrity indicator (e.g., a hash of a current memory image of HV 40) to a reference integrity indicator previously stored in protected storage module 36 of the respective client system (see, e.g., step 252 in FIG. 9). When the current and reference indicators do not match, some embodiments may halt booting operations. Such local integrity verification may prevent client system 12 from launching a corrupted version of HV 40. In an exemplary scenario wherein an attacker has successfully corrupted network appliance 20, the attacker may still be forced to distribute unaltered boot images to clients to avoid detection.

A step 310 may launch HV 40 into execution. Launching HV 40 further causes HV 40 to set up client VM 50 (step 312). In some embodiments wherein the client network filter executes in a separate virtual machine (see, e.g., FIG. 4-C), step 312 further includes setting up security VM 150, and configuring sharing of hardware devices between VM 50 and VM 150. Step 312 may further include configuring client system 12 to give security VM 150 exclusive use of network adapter(s) 34, and to re-route all network traffic through security VM 150.

In a sequence of steps 314-316, hypervisor 40 may initiate a measured boot of client OS 52, which may include loading OS 52 into a virtualized memory of client VM 50, and calculating a current OS integrity indicator (e.g., a hash of a memory image of client OS 52, or of specific parts of OS 52, such as the OS kernel and critical boot drivers). After determining the OS integrity indicator, a step 318 launches client OS 52 and applications 54a-b into execution.

In a step 320, client system 12 may activate client network filter 56. When the client network filter executes within client VM 50 (e.g., FIG. 4-A), filter 56 may initialize like any other application or system service. For instance, OS 52 may be configured to automatically launch client network filter 56 after boot. When the client network filter executes at the level of HV 40 (e.g., FIG. 4-B), step 320 may include starting security application 57 and configuring client network filter 156 to interface with application 57, for instance to handle VM exit events triggered by security application 57, and to set up a section of physical memory shared between HV 40 and client VM 50, the section of memory used to send data and/or messages between network filter 156 and security application 57. In some embodiments wherein the client network filter executes within a separate security VM (e.g., filter 256 in FIG. 4-C), step 320 may include configuring HV 40 to interface with client network filter 256, for instance to handle VM exit events triggered by filter 256, and to set up a section of physical memory shared between HV 40 and filter 256, the section of memory used to send data and/or messages between network filter 256 and HV 40.

In a step 322, hypervisor 40 configures introspection engine 58 to protect a set of software components executing within client VM 50 from unauthorized modification. In some embodiments, protected components include, among others, critical parts of client OS 52 and parts of client network filter 56. Step 322 may include identifying a set of memory pages containing code and/or data of the protected components, and protecting the respective memory pages from modification. Page protection may be achieved using several methods known in the art of virtualization and data security. In one such example, HV 40 configures a second-level address translation (SLAT) feature of processor 22, such as an extended page table (EPT) used by client VM 50, to trigger a processor event (e.g., processor exception or page fault) when detecting an attempt to access and/or modify the content of a protected page. In some embodiments, introspection engine 58 may be configured to protect objects executing outside client VM 50, for instance, client network filter 256 executing within security VM 150.

In a pair of steps 324-326, client system 12 carries out a mutual integrity transaction with network appliance 20. Client system 12 may transmit current client integrity indicators 76, such as indicators determined for HV 40 (step 308) and/or OS 52 (step 316), to network appliance 20. In exchange, client system 12 may receive current appliance integrity indicator 78 from appliance 20. The order of steps 318-326 may vary from one embodiment to another. Having a functional OS already running on client system 12 may facilitate communication with appliance 20, in the sense that HV 40 may use components of OS 52, such as a network driver, to transmit data to and receive data from network appliance 20. HV 40 may also perform steps 324-326 before launching OS 52, or even before loading OS 52 into memory, but to communicate with network appliance 20, HV 40 may need to implement additional components, such as a network stack, among others. To facilitate deployment of HV 40 and to improve user experience by expediting boot-up of client system 12, it may be preferable to use a relatively small boot image, corresponding to a version of HV 40 with a minimal set of features.

In a step 328, client system 12 (e.g., a component of HV 40 or client network filter 56) may verify the integrity of software executing on network appliance 20, to determine whether appliance 20 operates in a trusted state. Step 328 may comprise looking up a reference integrity indicator determined appliance 20, the reference indicator corresponding to the trusted state of appliance 20, and comparing current appliance integrity indicator 78 to the reference appliance integrity indicator. A match may indicate that network appliance 20 is in the trusted state.

When integrity verification concludes that appliance 20 is in the trusted state, in a step 332, client system 12 configures client network filter 56 to allow electronic communications between client system 12 and appliance 20. A mismatch between current appliance integrity indicator 76 and the reference appliance integrity indicator may denote an unauthorized and possibly malicious modification of network appliance software, e.g., by malware or by a user having access to network appliance 20. In such cases, a step 336 may configure client network filter 56 to restrict communications between client system 12 and network appliance 20. Restricting communications may comprise, for instance, block all network traffic between system 12 and network appliance 20. When appliance 20 is configured as a network gateway between local network 14 and extended network 16 (see, e.g., FIG. 1), such restrictions may effectively prevent client system 12 from sending and/or receiving data to/from outside local network 14. In some embodiments, a step 334 further alerts a system administrator.

The exemplary systems and methods described above allow protecting electronic devices connected to a local network, such as personal computers, tablet computers, and smartphones, from malware that may attempt to transmit sensitive information outside the local network. In typical applications, the local network may represent a corporate Intranet or a home network.

In one use case scenario, a user may remotely access a bank account through an e-banking platform hosted on a server computer system. To access the account, the user is typically required to provide some credentials, such as a password and/or an access code. A similar situation arises in e-commerce applications, wherein the user may also transmit sensitive information (e.g., credit card details) to a remote computer system. Such sensitive data is typically input by the user into an electronic device such as a computer, mobile phone, etc., connected to a communication network. It may be important to the user that sensitive data is not stolen, and that it is only transmitted to the intended destination.

In another use case scenario, employees of a company may need to access sensitive data stored on a corporate server and/or share sensitive data among them within a corporate network. Meanwhile, some computer systems on the corporate network may be configured to connect to the Internet. The company may want to ensure that sensitive corporate data does not leave the corporate network.

In yet another example, members of a family may use a variety of electronic devices, such as computers, tablet devices, mobile phones, TVs, and game consoles, among others. Many such devices have network connection capabilities, and may be configured to connect to the Internet, for instance, to access entertainment content. Parents may want to prevent some such devices, e.g., devices used by children, from accessing the Internet within certain time intervals, and/or from accessing certain types of online content. At the same time, family members may wish to protect their privacy, for instance, by preventing an unauthorized transmission of data from their home to outside parties.

In conventional computer systems, malware can compromise the safety and privacy of data exchange. Malware may attempt to steal private or sensitive information, and to transmit such information to remote parties. Malware may further disable conventional network defenses, such as firewalls and network filters, and may download and install spyware on the user's computer system. Modern malware may execute at processor privilege level similar or greater than that of the operating system, and may thus gain substantial control of the user's machine. Instead of using conventional anti-malware defenses executing on top of the OS, some embodiments of the present invention install a below-OS security component, in the form of a hypervisor. In some embodiments, the hypervisor takes control of the processor at the highest privilege level, and displaces the OS and other applications to a virtual machine. An introspection engine executing at the level of the hypervisor may then be used to protect software executing within the VM from malware. Such security components may execute without altering the user's experience, i.e., the user of the protected machine may be completely unaware that his/her applications are running within a virtual machine, instead of directly on the hardware platform of the respective computer system.

Some embodiments of the present invention further use a network appliance device distinct from the protected computer systems to distribute an image of the hypervisor to each protected computer system. By downloading the hypervisor from a certified trusted source every time the respective hypervisor is needed (e.g., at boot time), some embodiments ensure that the version of the hypervisor executed by the protected systems is not corrupted by malware. In addition, some embodiments use measured boot technology to build a hierarchy of trust for components executing on each protected system. The integrity of each component in a software hierarchy (firmware, hypervisor, OS, etc.) may be verified by the network appliance before the respective component is allowed to execute.

In conventional anti-malware and network filter systems, each protected system may run its own software (e.g., firewall) to control access of the respective system to the Internet. Such systems may be vulnerable to malware, which may disable the local anti-malware and/or network defenses. In contrast, in some embodiments of the present invention, the network appliance may be configured to control access of each protected computer system to the Internet from a central position, for instance from the position of a network gateway. In some embodiments, the network appliance only allows a protected system to access the Internet in response to verifying the integrity of software components (e.g., hypervisor, OS) executing on the respective system, and establishing that such software is in a trusted, unmodified state. In addition, each client system may run its own network filter, which may be configured to selectively block communication between the respective client system and the network appliance.

In conventional anti-malware systems, one side of an attestation transaction may be inherently trusted. For example, when a server is used to distribute software to a plurality of endpoints over a network, the server software is considered safe, by virtue of being monitored and controlled by a trusted user, e.g. a system administrator. Such systems may use one-sided integrity attestation, wherein the endpoints have their integrity verified by a central, trusted authority such as the said server. Asking an inherently untrusted entity such as a regular network endpoint to attest the integrity of the inherently trusted server may be counterintuitive.

However, an anti-malware system wherein only one component performs integrity attestation of other components may be vulnerable to malware attacks. Sophisticated attacks, for instance targeting valuable corporate assets, may proceed in multiple stages, first finding a weak link of anti-malware defenses to infect one computer system, and using the respective system as a springboard to infect another, more valuable computer system. In some cases, consecutive stages of an attack including the execution of various malicious payloads, may be separated by a substantial amount of time (e.g., several days to several months). For such an attack to succeed, a malware agent or backdoor module may have to survive undetected for a substantial period. In one example, wherein the network appliance performs integrity attestation of a client system, an attack may target the network appliance first. Malware installed on the network appliance may remain undetected indefinitely, since the integrity of the network appliance is not verified by another component of the anti-malware system. The network appliance may then be used as a springboard for later stages of the attack. In another example, wherein the client is configured to verify the integrity of the network appliance, an attack may target the client system first. Malware installed on the client system may remain undetected, so the client system may be used as a springboard for further attacks.

In contrast to one-sided integrity attestation, some embodiments of the present invention perform a mutual integrity attestation transaction between a protected client system and the network appliance, wherein each side of the transaction verifies the integrity of the other side. In such embodiments, a malware agent infecting either the client system or the network appliance may not survive a reboot of the respective device, without being detected by the other side via integrity attestation. To increase the rate of malware and/or cyberattack detection, some embodiments of network appliance may be configured to reboot repeatedly, for instance according to a schedule (e.g., daily or hourly). Such repeated rebooting may limit the time window of a malware attack to the interval between consecutive reboots.

Some conventional anti-malware systems employ measured launch technologies, such as trusted execution technology (TXT) from Intel®, to verify the integrity of software components such as the firmware interface and the operating system, before launching the respective components into execution. Such systems typically comprise computing a hash of a current instance of a software object to a locally-stored reference hash, and determining that the software object is trusted when the hashes match. However, using such local integrity attestation has disadvantages for a situation wherein a first system has to collaborate with a remote second system, for instance when the first system transmits sensitive information to the second system. Even when the second system uses a measured launch, the first system has to trust the integrity of the second system without having tangible proof of such integrity. In contrast, some embodiments of the present invention perform a remote integrity attestation between a protected client system and the network appliance. Each side of the transaction may receive an integrity indicator (e.g., a hash) from the other side, the indicator characterizing the current state of the other side. Each side may compare the received integrity indicator with a reference indicator characterizing a trusted state, and thus determine whether the other side of the transaction may be trusted.

In some embodiments of the current invention, the network appliance and protected client systems are deliberately configured using distinct hardware architectures. In one such example, wherein client systems are computer systems comprising x86 processors and chipsets, the network appliance may be built around an ARM® platform. The client system and network appliance may further use distinct operating systems, such as Linux® vs. Windows®, and may use distinct integrity attestation protocols and/or technologies, such as Intel TXT® vs. ARM TrustZone®. Such hardware and software configuration may prevent situations in which a vulnerability of one side of the mutual integrity attestation transaction may be used to successfully attack the other side.

It will be clear to one skilled in the art that the above embodiments may be altered in many ways without departing from the scope of the invention. Accordingly, the scope of the invention should be determined by the following claims and their legal equivalents.

What is claimed is:

1. A network appliance comprising at least one processor configured to execute a client boot agent and an appliance network filter connected to the client boot agent, wherein:
the client boot agent is configured to transmit a boot image over a network to a client system in response to receiving a boot request from the client system, wherein executing the boot image on a processor of the client system causes a booting of the client system; and
the appliance network filter is configured to:
determine whether the client system is in a trusted state of the client system according to a client integrity indicator received from the client system, the client integrity indicator characterizing an integrity of the client system; and
in response to determining whether the client system is in the trusted state of the client system:
allow electronic communications from the client system when the client system is in the trusted state of the client system, and
block electronic communications from the client system when the client system is not in the trusted state of the client system, and
wherein the client system is configured to:
determine whether the network appliance is in a trusted state of the network appliance according to an appliance integrity indicator received from the network appliance, the appliance integrity indicator characterizing an integrity of the network appliance; and
in response to determining whether the network appliance is in the trusted state of the network appliance:
employ a client network filter executing on the client system to allow electronic communications between the client system and the network appliance when the network appliance in the trusted state of the network appliance, and
employ the client network filter to block electronic communications between the client system and the network appliance when the network appliance is not in the trusted state of the network appliance.

2. The network appliance of claim 1, wherein executing the boot image on the processor of the client system causes the client system to launch a hypervisor configured to:
expose a client virtual machine (VM) on the client system, the client VM controlled by the hypervisor, and
load an operating system into the client VM, the operating system loaded from a local storage device of the client system.

3. The network appliance of claim 2, wherein the client integrity indicator characterizes an integrity of the hypervisor, and wherein determining whether the client system is in the trusted state of the client system includes determining whether the hypervisor is in a trusted state of the hypervisor.

4. The network appliance of claim 2, wherein the client integrity indicator characterizes an integrity of the operating system, and wherein determining whether the client system is in the trusted state of the client system includes determining whether the operating system is in a trusted state of the operating system.

5. The network appliance of claim 2, wherein the client network filter executes within the client VM.

6. The network appliance of claim 2, wherein the client network filter executes within a security VM exposed by the hypervisor, the security VM isolated from the client VM.

7. The network appliance of claim 1, wherein the client integrity measurement is cryptographically signed using a key specific to the client system.

8. The network appliance of claim 1, further configured to transmit the boot image to the client system over a wireless connection between the network appliance and the client system.

9. The network appliance of claim 1, wherein executing the boot image on the processor of the client system further causes the client system to launch an introspection engine executing below an operating system of the client system, the introspection engine configured to protect the client system from malware.

10. The network appliance of claim 1, further configured to transmit the appliance integrity indicator to the client system in response to every boot of the client system.

11. A client system comprising at least one processor configured to:
transmit a boot request to a network appliance over a network;
execute a boot image to boot the client system, the boot image received from the network appliance in response to transmitting the boot request;
in response to executing the boot image, determine whether the network appliance is in a trusted state of the network appliance according to an appliance integrity indicator received from the network appliance, the appliance integrity indicator characterizing an integrity of the network appliance; and
in response to determining whether the network appliance is in the trusted state of the network appliance:
allow electronic communications between the client system and the network appliance when the network appliance in the trusted state of the network appliance, and
block electronic communications between the client system and the network appliance when the network appliance is not in the trusted state of the network appliance, and
wherein the network appliance is configured to:
determine whether the client system is in a trusted state of the client system according to a client integrity indicator received from the client system, the client integrity indicator characterizing an integrity of the client system; and
in response to determining whether the client system is in the trusted state of the client system:
allow electronic communications from the client system when the client system is in the trusted state of the client system, and
block electronic communications from the client system when the client system is not in the trusted state of the client system.

12. The client system of claim 11, wherein executing the boot image causes the client system to launch a hypervisor, the hypervisor configured to:
expose a client virtual machine (VM) on the client system, the client VM controlled by the hypervisor, and
load an operating system into the client VM, the operating system loaded from a local storage device of the client system.

13. The client system of claim 12, wherein the client integrity indicator characterizes an integrity of the hypervisor, and wherein determining whether the client system is in the trusted state of the client system includes determining whether the hypervisor is in a trusted state of the hypervisor.

14. The client system of claim 12, wherein the client integrity indicator characterizes an integrity of the operating system, and wherein determining whether the client system is in the trusted state of the client system includes determining whether the operating system is in a trusted state of the operating system.

15. The client system of claim 12, wherein the network filter executes within the client VM.

16. The client system of claim 12, wherein the network filter executes within a security VM exposed by the hypervisor, the security VM isolated from the client VM.

17. The client system of claim 11, wherein executing the boot image further causes the client system to launch an introspection engine executing below an operating system of the client system, the introspection engine configured to protect the client system from malware.

18. The client system of claim 11, wherein the at least one processor is further configured to cryptographically sign the client integrity indicator using a key specific to the client system.

19. The client system of claim 11, wherein the at least one processor is further configured to transmit the client integrity indicator to the network appliance in response to executing the boot image.

20. A non-transitory computer-readable medium storing instructions which, when executed on a processor of a network appliance, cause the network appliance to form a client boot agent and an appliance network filter connected to the boot agent, wherein:
the client boot agent is configured to transmit a boot image over a network to a client system in response to receiving a boot request from the client system, wherein executing the boot image on a processor of the client system causes a booting of the client system; and
the appliance network filter is configured to:
determine whether the client system is in a trusted state of the client system according to a client integrity indicator received from the client system, the client integrity indicator characterizing an integrity of the client system; and
in response to determining whether the client system is in the trusted state of the client system:
allow electronic communications from the client system when the client system is in the trusted state of the client system, and
block electronic communications from the client system when the client system is not in the trusted state of the client system, and
wherein the client system is configured to:
determine whether the network appliance is in a trusted state of the network appliance according to an appliance integrity indicator received from the network appliance, the appliance integrity indicator characterizing an integrity of the network appliance; and
in response to determining whether the network appliance is in the trusted state of the network appliance:
employ a client network filter executing on the client system to allow electronic communications between the client system and the network appliance when the network appliance in the trusted state of the network appliance, and
employ the client network filter to block electronic communications between the client system and the network appliance when the network appliance is not in the trusted state of the network appliance.
